(19) United States
(12) Patent Application Publication
(10) Pub. No.: US 2007/0052134 A1
(43) Pub. Date: Mar. 8, 2007

(54) PLANAR ELEMENTS INCORPORATING BASALT FIBERS FOR USE IN PAPERMAKING APPARATUS

(76) Inventors: Michael Draper, Lancashire (GB); John James, Todmordon (GB); John Rotherham, Bolton (GB)

Correspondence Address: GAUTHIER & CONNORS, LLP, 225 FRANKLIN STREET, SUITE 2300, BOSTON, MA, 02110, US

(21) Appl. No.: 11/469,912

(22) Filed: Sep. 5, 2006

Related U.S. Application Data
(60) Provisional application No. 60/715,309, filed on Sep. 8, 2005.

(51) Int. Cl. D21G 3/04; B29C 67/00; B29C 45/14

(52) U.S. Cl. 264/257; 162/280; 162/281; 15/256.5; 15/256.51; 118/413; 118/261; 264/137; 264/160; 264/324

(57) ABSTRACT

A planar element is disclosed for use in a papermaking machine. The planar element includes a composite of multiple layers, with at least some of the layers including resin impregnated fabrics including basalt fibers.

### PRIORITY

The present application claims priority to U.S. Provisional Patent Application Ser. No. 60/715,309 filed Sep. 8, 2005.

### BACKGROUND DISCUSSION

1. Field of the Invention

This invention relates generally to planar elements employed in papermaking machines. As herein employed, the term planar element is intended to encompass doctor blades, creping blades, coater blades, top plates in blade holders, and wear surfaces on foil blades.

2. Description of the Prior Art

Doctor blades contact the surface of rolls on papermaking and web converting machines for the purpose of cleaning or sheet removal.

Synthetic doctor blades are comprised of fabric substrates held together by polymeric resins, with the combination of substrate and resin providing the desired properties for efficient doctoring. Composite doctor blades are typically made using glass, cotton or carbon reinforcement fabrics, and are held together with either thermoplastic or thermoset resins. The different reinforcement fabrics impart different performance properties to the laminates. Experience has shown however, that glass reinforcements can be too aggressive for some roll surfaces, and may result in roll damage. Moreover, doctor blades with glass fabric tend to run with higher frictional drag resulting in more energy being needed to maintain a fixed roll speed.

Carbon reinforcements on the other hand, while both longer lasting and kinder to roll surfaces (less frictional drag), do not clean as aggressively, since carbon is less abrasive than glass. Both glass and carbon reinforcements out-perform cotton composites in terms of both life and cleaning capability.

There is a need, therefore, for a doctor blade that provides excellent long lasting cleaning performance yet low frictional drag.

### SUMMARY

A planar element is disclosed for use in a papermaking machine. The planar element includes a composite of multiple layers, with at least some of the layers including resin impregnated fabrics including basalt fibers. In further embodiments, the planar element is a doctor blade and the basalt fibers are woven.

### DETAILED DESCRIPTION

In a broad sense, the present invention stems from the discovery that when used to reinforce planar elements, basalt fibers have proven to be more abrasive than carbon and longer lasting than glass, with better acid, alkali and solvent resistance than both, resulting in enhanced and more efficient performance. Such doctor blades have been found to exhibit doctoring performance capabilities similar to glass fiber doctor blades, but with reduced frictional drag.

Basalt fibers are made from inert, solidified volcanic lava. Basalt rock has long been known for its thermal properties, strength and durability. Techniques are available to produce the mineral in continuous filament form, and fibers may be made from such filaments. Basalt fibers are currently finding application as geo-textiles and geo-meshes for highway reinforcement and soil stabilization, due to their exceptional durability. They are stronger and more stable than both other mineral and glass fibers (15%-20% higher tensile strength and modulus than electrical grade glass (E-glass)), and have a tenacity that by far exceeds that of steel fibers. These tough and long lasting fibers also have excellent acid, alkali, moisture and solvent resistance with a melting point of 1350° C. They are environmentally friendly and non-hazardous with both high temperature resistance and low water absorption.

In accordance with one embodiment of the present invention, fabrics woven from Basalt fibers are sized for epoxy resin compatibility. The sized fabrics are then coated with epoxy type resins and are B-staged using a resin impregnation/pre-preging process. The resin, therefore, is not fully cured on the fabric: it is dry and tack free but not fully reacted, and will flow and react/crosslink when exposed to an elevated temperature. If a pre-preging process is employed, the reinforcement fabric is pre-coated with resin prior to lamination. Several layers of the resin coated fabrics are then laminated together, using sufficient heat and pressure to both cure the resin and consolidate the laminate. The resulting laminate is then machined into the planar element, e.g., a doctor blade, by conventional techniques known to those skilled in the art.

### EXAMPLE 1

Fabric type BSL 220 from the Basaltex division of Group Masureel of Wevelgem, Belgium was selected for incorporation into a composite doctor blade. This fabric is made from 100% BCF (Basalt Continuous Filament) fibers woven into a 220 gsm plain weave construction with ten ends per cm in the warp and 9.6 ends per cm in the weft.

The BSL 200 fabric was sized with amino silane (P8) for epoxy resin compatibility. The sized fabrics were then coated with an epoxy type resin, Bisphenol A epoxy supplied by Vantico Ltd. of Duxford, Cambridge, U.K., and B-staged using a resin impregnation/pre-preging process. Ten layers of resin impregnated fabric were then laminated together to produce a doctor blade with a thickness of 1.66 mm and a glass transition temperature of 160° C.

### EXAMPLE 2

A doctor blade was produced as described in Example 1, with the only difference being the use of epoxy novolac obtained from Vantico Ltd. as the binding resin, thus yielding a glass transition temperature of 180° C. for the resulting doctor blade. In various embodiments, the doctor blade may have a glass transition temperature between about 120° C. and about 350° C., and preferably between about 160° C. and about 180° C. In further embodiments, the doctor blade may have a thickness of between about 0.8 mm to about 3.0 mm, and preferably from about 1.0 mm to about 2.0 mm.

In laboratory tests, the basalt fabric reinforced polymer composites of Examples 1 and 2 showed similar mechanical wear resistance/abrasion resistance, with typically 15% less frictional drag, when compared to equivalent glass blades when used as a doctor blade running against a dry steel roll, rotating at 1000 m per minute/668 revs per minute, set at an angle of 25° with a load of 0.178 kg/cm (1 pli).

Thus, the basalt reinforced laminates of the present invention are particularly well suited for use in modern high speed paper machines, since they have the potential to operate with similar cleaning performance and lifetimes to glass equivalents but with reduced frictional drag. Such laminates, therefore have the potential to enable paper machines to run at a constant speed using less power consumption or at a faster speed using the same energy consumption and additionally will be less damaging to the roll surface, since the fibers are not as abrasive as glass fibers.

The basalt fibers used in certain embodiments of the present invention are stronger and more stable than those reinforced with other mineral and glass fibers (15%-20% higher tensile strength and modulus than E-glass of low sodium oxide content), and have a tenacity that by far exceeds that of steel fibers. These tough and long lasting fibers also have excellent acid, alkali, moisture and solvent resistance. They are environmentally friendly and non hazardous with both high temperature resistance and low water absorption. Basalt fibers, therefore, have ideal properties for producing an enhanced fiber reinforced doctor blade.

As an alternative embodiment of this invention, a fabric reinforced composite planar element could be produced with differing combinations of layers of basalt fiber and layers of glass to exploit the synergistic effects of combining the basalt and glass reinforcements.

As a further alternative embodiment of this invention, a fabric reinforced composite planar element could be produced with differing combinations of layers of basalt fiber and layers of carbon fiber to exploit the synergistic effects of combining the basalt and carbon reinforcements.

Still another alternative embodiment would be to combine layers of basalt, glass and carbon, to exploit the synergistic effects of combining all three reinforcement materials. Basalt fibers are also available in woven fabrics, non-woven, unidirectional fabric, bi-, tri- and multi-axial fabrics, needle punched mat felt and as chopped strands, each of which may be used in accordance with various embodiments of the invention.

Further embodiments may be made by using these different orientations of basalt fiber construction either alone or in combination to produce reinforced composite planar elements.

For example, Kamenny Vek Advanced Basalt Fiber from Moscow, Russia, produces fabrics using multiple axis (0°, 90°, +45° & −45°), as well as orientations from +20 through to +90° and −20° to −90° in the weight range from 100 gsm to 3000 gsm. These fabrics may be combined with chopped basalt fiber, which could be used as a surfacing veil in a basalt fiber reinforced composite planar element.

Wear test trials of a doctor blade of Example 2 above (10 layers of woven basalt plain wave fabrics coated with epoxy novolac resin), running against a 1 meter wide dry chilled cast iron roll, rotating at 1000 m per minute/668 revs per minute, set at an angle of 25° with a load of 0.178 kg/cm (1 pli) and a surface roughness of 3 Ra at 1000 m/min., showed that a basalt doctor blade only lost 0.66 g per hour over 100 hours, compared to a conventional 10 layer glass doctor blade, which lost 1.17 g per hour over 100 hours. Thus the Basalt fiber doctor blade showed a reduced wear rate of 44% over the 100 hour test. The blade drag on the roll caused the roll to require 17 amps of current to maintain a speed of 1000 meters per minute, compared to the 20 amps of current required by a conventional 10 layer glass reinforced doctor blade and 14.4 amps required by a conventional carbon reinforced doctor blade. The basalt reinforced doctor blade, therefore, presented 15% less drag than a conventional glass reinforced doctor blade, and 18% more drag than a conventional carbon reinforced doctor blade. The above basalt reinforced doctor blade, therefore, should be more aggressive and better at cleaning than a carbon doctor blade, but kinder to the roll than a glass reinforced doctor blade. Therefore, a basalt doctor blade provides a better universal doctor blade than either of the traditional glass or carbon doctor blades. Basalt fibers show 15%-20% increase in tensile strength than E-glass (ASTM D2343) and 15%-20% better tensile modulous (ASTMD2343). They also display better chemical resistance than E-glass.

The specific crystalline structure of the basalt fibers encourages good wet-out of the fibers with resin during impregnation which consequently improves interlayer adhesion and means that the doctor blade is more resistant than E-glass type blades, particularly to the acids and alkalis used to wash down the rolls. The basalt doctor blade is, therefore, more able to withstand the aggressive conditions experienced during application and is therefore, more suitable for use in a doctor blade construction.

Basalt fibers also have a very low water absorption meaning that basalt doctor blades will not absorb water during application which makes them less likely to distort or delaminate.

Those skilled in the art will appreciate that numerous modifications and variations may be made to the above disclosed embodiments without departing from the spirit and scope of the invention.

What is claimed is:

1. A planar element for use in a papermaking machine, said planar element: comprising a composite of multiple layers, with at least some of said layers comprising resin impregnated fabrics including basalt fibers.

2. The planar element of claim 1, wherein said composite includes multiple layers of resin impregnated woven basalt fibers that are laminated together.

3. The planar element of claim 2, wherein said basalt fibers in each layer are formed of continuous filaments.

4. The planar element of claim 3, wherein each of said multiple layers of basalt fibers has an axis of orientation, and adjacent layers have non-parallel axes of orientation.

5. The planar element of claim 1, wherein said composite includes at least one layer including chopped basalt fiber.

6. The planar element of claim 1, wherein said composite includes at least one layer including a resin impregnated fabric made from glass fibers.

7. The planar element of claim 1, wherein said composite includes at least one layer including a resin impregnated fabric made from carbon fibers.

8. The planar element of claim 1, comprising a doctor blade with a working edge configured for application to a roll surface, and said working edge includes resin coated basalt fibers.

9. The planar element of claim 1, wherein said planar element provides less wear during use as a doctor blade over a fixed period of time than an equivalent planar composite that includes glass fibers in place of the basalt fibers.

10. The planar element of claim 1, wherein said planar element requires less power during use as a doctor blade over a fixed period of time than an equivalent planar composite that includes glass fibers in place of the basalt fibers.

11. The planar element of claim 1, wherein said planar element has a glass transition temperature of between about 120° to 350° C.

12. The planar element of claim 1, wherein said planar element has a glass transition temperature of between about 160° to 180° C.

13. The planar element of claim 1, wherein said planar element has a thickness of between about 0.80 mm and about 3.50 mm.

14. The planar element of claim 1, wherein said planar element has a thickness of between about 11.0 mm and about 2.00 mm.

15. A method of providing a doctor blade for use in a papermaking machine, said method comprising the steps of:
resin impregnating a plurality of fabrics that include basalt fibers;
laminating said resin impregnated fabrics together to provide a doctor blade; and
mounting said doctor blade on a support structure for papermaking.

16. The method as claimed in claim 15, wherein said method further includes the step of orienting said fabrics prior to the step of laminating said resin impregnated fabrics together such that an axis of orientation of each fabric is non-parallel with an axis of orientation of an adjacent fabric.
